(19) United States
(12) Patent Application Publication
(10) Pub. No.: US 2025/0382400 A1
(43) Pub. Date: Dec. 18, 2025

(54) OLEFIN POLYMERIZATION METALLOCENE CATALYST COMPOSITION, PREPARATION THEREOF AND USE THEREOF

(71) Applicant: PetroChina Company Limited, Beijing (CN)

(72) Inventors: Huashu Li, Beijing (CN); Xinle Li, Beijing (CN); Shixuan Xin, Beijing (CN); Yi Zhou, Beijing (CN); Hongfan Hu, Beijing (CN); Xin Sun, Beijing (CN); Xueqin Zhang, Beijing (CN); Yang Li, Beijing (CN); Caizhong Hu, Beijing (CN)

(21) Appl. No.: 18/878,396

(22) PCT Filed: Dec. 14, 2022
(86) PCT No.: PCT/CN2022/138874

§ 371 Date: Dec. 23, 2024

(30) Foreign Application Priority Data
Jun. 22, 2022 (CN) 202210714628.2

(51) Int. Cl. C08F 110/06

(52) U.S. Cl. CPC C08F 110/06; C08F 2420/07; C08F 2420/10

(57) ABSTRACT

An olefin polymerization catalyst composition, comprising a main catalyst and a carrier. The carrier is fluorinated silica gel particles, and the main catalyst is a metallocene complex represented by general formula (I).

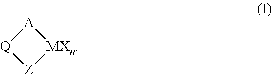

Also disclosed are the preparation of the composition and use of the composition in olefin polymerization reactions. The composition provided by the present invention can reduce or avoid the use of methylaluminoxane or borate reagents while improving polymer morphology.

### TECHNICAL FIELD

The present disclosure relates to a metallocene catalyst composition, a preparation method and its use in olefin polymerization.

### BACKGROUND

Due to the abundant substitution chemistry on the indene ring (Halterman, R. L. Chem. Rev. 1992, 92, 965), unlimited combination of substituents at positions 1 to 7 on the indene ring, and the potential scientific, technical, and commercial values thereof, great attention has been paid in the past thirty years to Group 3 and Group 4 metallocene complex catalysts based mainly on substituted indenes for olefin polymerization, especially bridged Group 4 metallocene complex catalysts for olefin polymerization (Luigi Resconi, Luigi Cavallo, AnnaFait, and Fabrizio Piemontesi, Chemical Reviews 2000, 100, 1253). Group 4 transition metallocene complexes having a bridged, substituted indene as ligand has actually become dominant in metallocene chemistry, providing not only plenty of strong experimental evidences for the development of organometallic chemistry theories, but also various catalysts having special properties in the polyolefin industry and for high-selectivity organic synthetic chemistry (Metallocenes in Regio- and Stereoselective Synthesis, T. Takahashi Ed, Springer, 2005). In brief, the development of metallocene complex catalysts has significantly contributed to elucidation of mechanisms in α-olefin stereospecific polymerization, diversification of olefin materials of different varieties and specifications, and providing novel olefin materials having special properties (-Based Polyolefin; J. Scheirsand W. Kaminsky Eds. Wiley, 2000.).

In the development of metallocene complex catalysts, in addition to the group of numerous metallocene complexes formed of the classic bridged substituted-cyclopentadienyl (Cp′), bridged substituted-indenyl (Ind′), bridged substituted fluorenyl (Flu′), and any combinations of Cp′, Ind′ and/or Flu′ with each other (Metallocenes: Synthesis, Reactivity, Applications, A. Togni and R. L. Halterman Eds, Wiley, 1998), a certain number of metallocene complexes have in recent years introduced heteroatoms such as nitrogen, phosphorus, oxygen or sulphur into the cyclopentadienyl (Cp) ring or a saturated or unsaturated ring adjacent to the Cp ring. These metallocene complexes including a heterocyclic ring either has a specific polymerization activity for olefins, or has a specific regioselectivity or stereoselectivity (C. De Rosa, F. Auriema, A. Di Capua, L. Resconi, S. Guidotti, I. Camurati, I. E. Nifant'ev, I. P. Laishevtsev, J. Am. Chem. Soc. 2004, 12, 17040). For example, CA2204803 describes a metallocene complex containing phosphorus heteroatoms and its excellent activity for catalytic ethylene polymerization and resultant molecular weight distribution, as well as the remarkable high-temperature catalytic activity thereof. A Group-4-element metallocene complex catalytic system associated therewith may produce high molecular weight polyethylene by catalytic ethylene polymerization at high temperature. WO9822486 and EP9706297 describe a class of metallocene complexes in which the 5-member side ring, adjacent to the Cp ring, contains oxygen, and/or sulphur and/or nitrogen. Such complexes have a very high polymerization activity for propylene when bonding with methyl aluminoxane (MAO). WO0144318 describes a metallocene complex having a sulphur-containing «-ligand and a process for catalytic copolymerization of ethylene and propylene using the same; however, the resulting ethylene-propylene copolymer has no value in practical application due to its low molecular weight. WO03045964 describes a process for producing a class of zirconocene complexes having a substituted sulpho-pentalene and a substituted indene bridged by dimethylsilyl, and a process for catalytic copolymerization of ethylene and propylene using the same. With the process described in WO03045964, the zirconocene complexes have very high polymerization activity, and the resulting ethylene-propylene copolymer has a higher molecular weight, an ethylene content in the copolymer of between 4% and 13% by weight, with its material characteristics between RCP and TPE.

U.S. Pat. No. 6,756,455 describes a class of nitrogen-containing π-ligand zirconocene complexes, especially a zirconocene complex catalyst coordinated with a bridged indenopyrrole derivative and a bridged indenoindole derivative. Such zirconocene complexes, when used in ethylene homopolymerization, has high activity and result in high molecular weight and a double-peak molecular weight distribution under proper conditions. U.S. Pat. No. 6,683,150 discloses a Group 4 translation metallocene complex catalyst having a bridged indenoindole derivative as ligand, and further discloses various examples in which propylene polymerization is catalyzed in a broad temperature range to produce high molecular weight polypropylene. WO03089485 provides a catalyst system formed by a class of Group 4 translation metallocene complex catalyst having nitrogen-containing π-ligand in combination with methyl aluminoxane (MAO), characterized in that the catalyst system has a very low aluminum/metal ratio, high activity, and capability of producing high-molecular-weight and linear low-density polyethylene (mLLDPE), when used with a proper support. WO9924446 describes a class of metallocene complexes formed by nitrogen heteroatom-containing π-ligands and Group 4 transition metals. Such metallocene complexes are easy to synthesize with a high yield, and are also good catalysts for olefin polymerization upon activation by methyl aluminoxane (MAO) or modified methyl aluminoxane (MMAO), to produce high-molecular-weight polyethylene and polypropylene respectively by polymerization.

In the applications of polymerization production, in order to obtain high catalytic activity, the amounts of aluminoxane reagents or borate reagents used together with metallocene complexes is large, and their molar ratios with metallocene complexes often reach more than 500 folds and sometimes even up to several thousand folds. Aluminoxane reagents or borate reagents are expensive, and their high dosage leads to high production costs of metallocene catalysts. In addition, metallocene catalysts, as homogeneous catalysts, produce polymer products with poor morphology, which are easy to cause clogging of polymerization kettles and devices during polymerization and product delivery, and are poorly adapted to industrial devices, resulting in difficulties in industrial use. Therefore, the technical problems that need to be improved or solved in the industrial application of these catalysts are to ensure the polymerization activity level of metallocene catalysts, to reduce the amounts of aluminoxane reagents and borate reagents or even to avoid the use of aluminoxane reagents and borate reagents, and to improve the morphology of polymers.

### SUMMARY

One of the objects of the present disclosure is to provide a catalyst composition for olefin polymerization to reduce or avoid the use of methylaluminoxane or borate reagents while improving the morphology of polymers. It is another object of the present disclosure to provide a preparation method of the catalyst composition for olefin polymerization. A further object of the present disclosure is to provide a use of the catalyst composition for olefin polymerization in olefin polymerization.

An embodiment of the present disclosure relates to a catalyst composition for olefin polymerization comprising a main catalyst and a support, wherein the support is fluorinated silica gel particles, and the main catalyst is a metallocene complex represented by general formula (I):

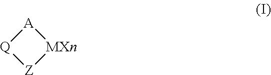

wherein M is a transition metal element from Group 3, Group 4, Group 5 and Group 6 in the periodic table, including element of lanthanides and actinides;
Xs, being the same or different from each other, are selected from hydrogen, halogen, an alkyl group R, an alkoxyl group OR, a mercapto group SR, a carboxyl group OCOR, an amino group NR₂, a phosphino group PR₂, —OR^{o}O— and OSO₂CF₃; R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms; R^{o} is a divalent radical, including a C₂-C₄₀ alkylene group, a C₆-C₃₀ arylene group, an alkyl-substituted arylene group having 7 to 40 carbon atoms, or an aryl-substituted alkylene group having 7 to 40 carbon atoms; in the structure of —OR^{o}O—, the two oxygen atoms are located at any positions in the radical, respectively;
n is an integer from 1 to 4; the total charge number of the n Xs equals to the charge number of M minus 2;
Q is a divalent radical, including ═CR′₂, ═SiR′₂, ═GeR′₂, ═NR′, ═PR′, ═BR′, wherein R′ is methyl, ethyl, isopropyl, trimethylsilyl, phenyl, or benzyl;
A is a π-ligand having a structure represented by chemical formula (II):

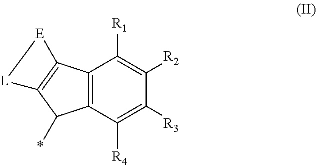

E is a biradical of an element of Group 15 or 16 in the periodic table, including an oxygen radical, a sulfur radical, a selenium radical, NR″ or PR″; wherein R″ is a C₁-C₁₀ linear alkyl group, phenyl, mono- or multi-substituted phenyl, benzyl, mono- or multi-substituted benzyl, 1-naphthyl, 2-naphthyl, 2-anthryl, 1-phenanthryl, 2-phenanthryl, or 5-phenanthryl;
L is a divalent radical having a structure represented by the chemical formula (III), (IV), (V), (VI), (VII) or (VIII):

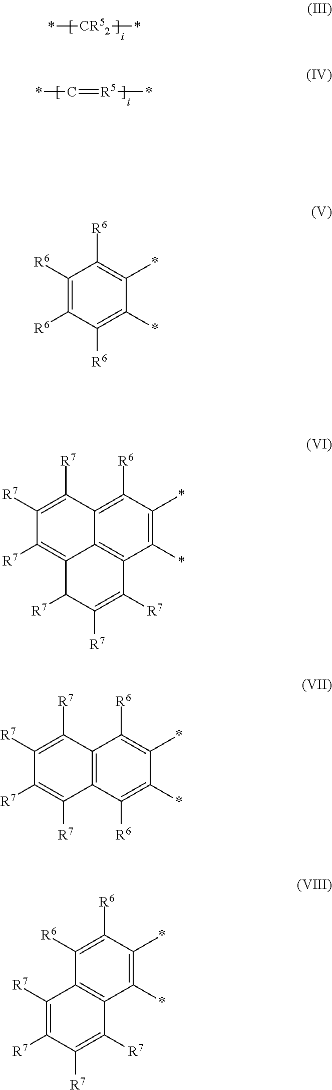

wherein i is 2;
Z is a π-ligand, wherein Z=A, or Z has a chemical structure represented by the following chemical formula (IX), (X), (XI), (XII) or (XIII):

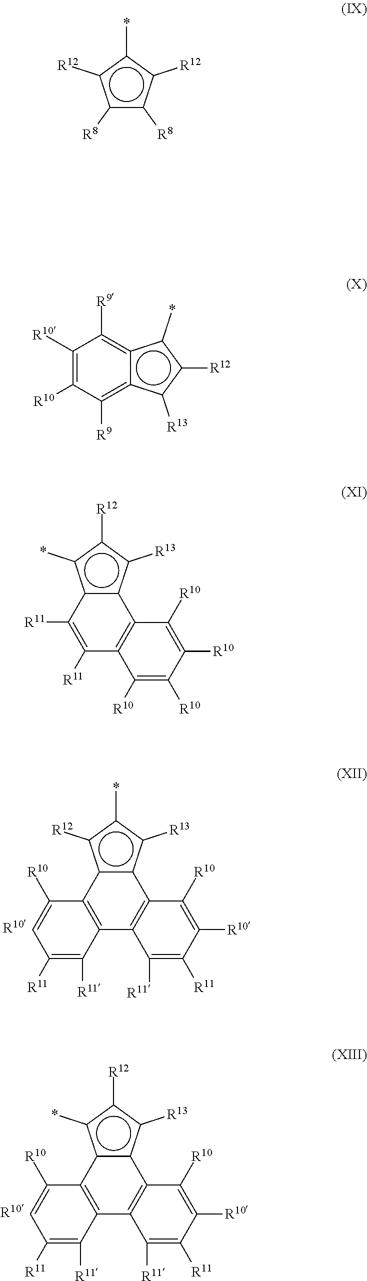

wherein R¹ and R¹² are hydrogen, methyl, ethyl, isopropyl, t-butyl, phenyl, benzyl, 2-furyl, or 2-thienyl;
R², R³ and R¹³ are each independently hydrogen, fluoro, or R, wherein R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
R⁴ is H, methyl, trifluoromethyl, isopropyl, t-butyl, phenyl, p-tert-butylphenyl, p-trimethylsilylphenyl, p-trifluoromethylphenyl, 3,5-dichloro-4-trimethylsilylphenyl, or 2-naphthyl;
R⁵ is hydrogen, fluoro, or methyl;
R⁶ and R⁷ are each independently hydrogen, fluoro, or R, wherein R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
R⁸ is methyl, ethyl, isopropyl, t-butyl, or phenyl;
R⁹ and R^{9′} are phenyl, substituted phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, furan, thienyl, quinolinyl, or pyrimidinyl, wherein the substituent in the substituted phenyl is cyano, nitro, F, methyl, ethyl, isopropyl, t-butyl, methoxy, t-butyl, trifluoromethoxy, Cl, trifluoromethyl, carbonyl, or trimethylsilyl;
R¹⁰ and R^{10′} are hydrogen, fluorine, chlorine, methyl, ethyl or phenyl;
R¹¹ and R^{11′} are hydrogen, fluoro, chloro, an ester group, an alkoxyl group, a mercapto group, an amino group or a phosphino group.

Herein, in chemical formula (I), A is a monovalent anionic π-ligand having a chemical structure represented by chemical formula (II)—Li⁺; chemical formula (II) includes a basic structure having a cyclopentadienyl ring, while the active hydrogen in the cyclopentadienyl structure has electrophilic reactivity and can react with a nucleophilic agent in an exchange reaction to produce the compound represented by chemical formula (II)—Li⁺, and the basic reaction thereof is shown as:

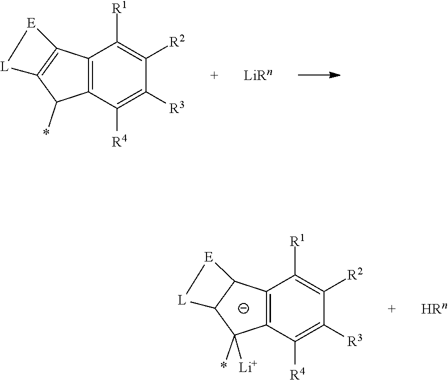

Herein, the nucleophilic agent in the reaction is an organolithium agent LiRⁿ, wherein Rⁿ is a C₁-C₆ alkyl group or a C₆-C₁₂ aryl group.

Herein, the symbol * connecting to a chemical bond, an atom, or a radical in the chemical formula (II) indicates that the site linked to * forms a chemical single bond with a chemical bond, atom or radical of the same kind.

Herein, X is chloro, bromo, a C₁-C₂₀ lower alkyl group, or an aryl group.

Specifically, in the chemical formula (I):

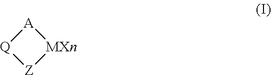

M is a transition metal element from Group 3, Group 4, Group 5 and Group 6 in the periodic table, including lanthanides and actinides; preferably a metal element from Group 3, Group 4, or lanthanides; and most preferably zirconium, hafnium or titanium from Group 4.
Xs, being the same or different from each other, are selected from hydrogen, halogen, an alkyl group R, an alkoxyl group OR, a mercapto group SR, a carboxyl group OCOR, an amino group (NR₂), a phosphino group (PR₂), —OR^{o}O— or OSO₂CF₃.

Herein, R is a straight or branched, saturated or unsaturated, halogenated or non-halogenated C₁-C₂₀ alkyl group, or a C₁-C₂₀ alkyl group optionally including a heteroatom from Groups 13 to 17 in the periodic table, or a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms. Examples of C₁-C₂₀ saturated alkyl group and halogenated alkyl group, include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the alkyl-substituted aryl group having 7 to 30 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the aryl-substituted alkyl group having 7 to 30 carbon atoms include, but are not limited to, benzyl, p-methylbenzyl, p-fluorobenzyl, p-chlorobenzyl, p-ethylbenzyl, p-isopropylbenzyl, p-tert-butylbenzyl, or the like p-trifluoromethylbenzyl, p-trimethylsilylbenzyl, 3,5-difluorobenzyl, 3,4,5-trifluorobenzyl, 3,5-bis-trimethylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.
R^{o} is a divalent radical, such as a C₂-C₄₀ alkylene group, a C₆-C₃₀ arylene group, an alkyl-substituted arylene group having 7 to 40 carbon atoms, or an aryl-substituted alkylene group having 7 to 40 carbon atoms; in the structure of —OR^{o}O—, the two oxygen atoms may be at any position of the radical, respectively; preferably, the positions of the two oxygen atoms are the combination of the ortho-positions (α,β-positions) and the meta-positions (α,γ-positions) in the radical. In the combinations as described above, X is preferably halogen (chloro, bromo), a lower alkyl group, or an aryl group such as, but not limited to, methyl, phenyl, or benzyl.
n is an integer from 1 to 4. The total charge number of n X's equals to the charge number of M minus 2.
Q is a divalent radical, such as ═CR′₂, ═SiR′₂, ═GeR′₂, ═NR′, ═PR′, ═BR′.

Herein, R's, being the same or different, are a straight or branched, saturated or unsaturated, halogenated or non-halogenated C₁-C₂₀ alkyl group, or a C₁-C₂₀ alkyl group including a heteroatom from Groups 13 to 17 in the periodic table, or a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms. Examples of the C₁-C₂₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the alkyl-substituted aryl group having 7 to 30 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the aryl-substituted alkyl group having 7 to 30 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

In the combinations as described above, R′ is preferably methyl, ethyl, isopropyl, trimethylsilyl, phenyl, or benzyl. A is a π-ligand having a general structure represented by chemical formula (II):

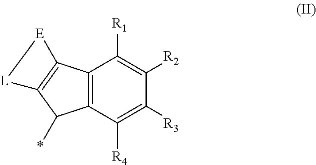

In the chemical formula (II), the symbol * represents that, whether linked to a chemical bond, an atom, or a radical, the site can form a chemical single bond with a chemical bond, atom or radical of the same kind. Hereinafter, the symbol * in all cases have the same meaning.

E is a biradical of an element of Group 15 or 16 in the periodic table, such as an oxygen radical, a sulfur radical, an arsenium radical, NR″ and PR″.

Herein, R″ is a straight or branched, saturated or unsaturated, halogenated or non-halogenated C₁-C₂₀ alkyl group, or a C₁-C₂₀ alkyl group including a heteroatom from Groups 13 to 17 in the periodic table, or a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms. Examples of the C₁-C₂₀ saturated alkyl and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethyl silicyl, triethyl silicyl, triphenyl silicyl, and the like. Examples of the C₁-C₂₀ unsaturated alkyl group include, but are not limited to, vinyl, propenyl, allyl, and the like. Examples of the C₃-C₂₀ cycloalkyl group include, but are not limited to, cyclopropyl, cyclobutyl, cyclopentyl, cyclohexyl, cyclooctyl, 1-adamantanyl, and the like. Examples of the C₆-C₃₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 30 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the aryl-substituted alkyl group having 7 to 30 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

In the combinations as described above, R″ is preferably a C₄-C₁₀ linear alkyl group, phenyl, mono- or multi-substituted phenyl, benzyl, mono- or multi-substituted benzyl, 1-naphthyl, 2-naphthyl, 2-anthryl, 1-phenanthryl, 2-phenanthryl, or 5-phenanthryl. Hereinafter, the R″ in all cases have the same meaning.
E is preferably an element such as sulfur or oxygen, NR″, and PR″, in which R″ is defined as above.
R¹ is any one of the following: a saturated or unsaturated, halogenated or non-halogenated C₁-C₄₀ alkyl group, optionally including a heteroatom from Groups 13 to 17 in the periodic table, or C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilicyl, triethylsilicyl, triphenylsilicyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.
R¹ is preferably hydrogen, methyl, ethyl, isopropyl, t-butyl, phenyl, benzyl, 2-furyl, or 2-thienyl. Hereinafter, the R¹ in all cases have the same meaning.
R² and R³ are hydrogen, fluoro, or R. R is defined as above. R² and R³ are preferably hydrogen. Hereinafter, the R² and R³ in all cases have the same meaning.
R⁴ is any one of the following: a saturated or unsaturated, halogenated or non-halogenated C₁-C₄₀ alkyl group, optionally including a heteroatom from Groups 13 to 17 in the periodic table, C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, propyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.
R⁴ is preferably H, methyl, trifluoromethyl, isopropyl, t-butyl, phenyl, p-tert-butyl-phenyl, p-trimethylsilyl-phenyl, p-trifluoromethyl-phenyl, 3,5-dichloro-4-trimethylsilylphenyl, or 2-naphthyl. Hereinafter, the R⁴ in all cases have the same meaning.
L is a divalent radical having any one of the following structures represented by general chemical formulae (III), (IV), (V), (VI), (VII) and (VIII):

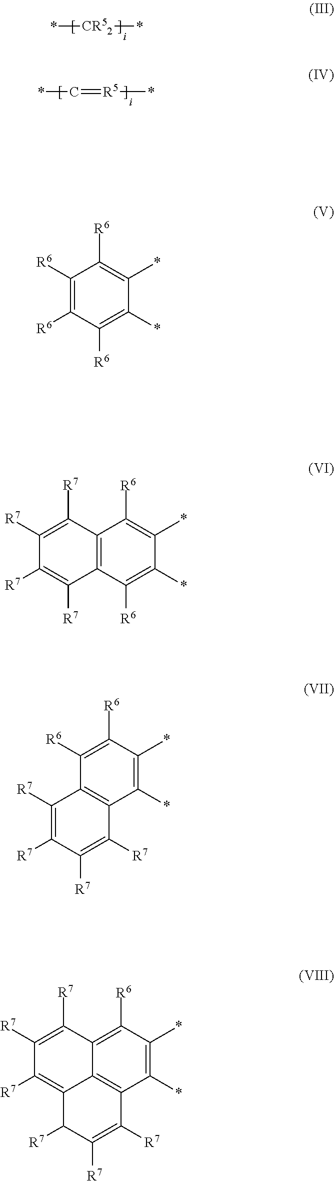

The symbol * indicates that, whether connecting to a chemical bond, an atom, or a radical, the site can form a chemical single bond with a chemical bond, atom or radical of the same kind. Hereinafter, the symbol * in all cases have the same meaning.

In general chemical formulae (III) and (IV): i is an integer and is not zero, and is preferably 2.

R⁵, being the same or different, is any one of the following: a saturated or unsaturated, halogenated or non-halogenated C₁-C₄₀ alkyl group, optionally including a heteroatom from Groups 13 to 17 in the periodic table, and C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁵ is preferably hydrogen, fluoro, or methyl. Hereinafter, the R⁵ in all cases have the same meaning.

In general chemical formulae (V), (VI), (VII) and (VIII), R⁶ and R⁷ are equivalent to R³ as defined above. R⁶ and R⁷ are preferably hydrogen or fluorine. Hereinafter, the R⁶ and R⁷ in all cases have the same meaning.

In general chemical formula (I): Z is π-ligand, wherein Z=A, or Z has a chemical structure represented by the following chemical formula (IX), (X), (XI), (XII) or (XIII):

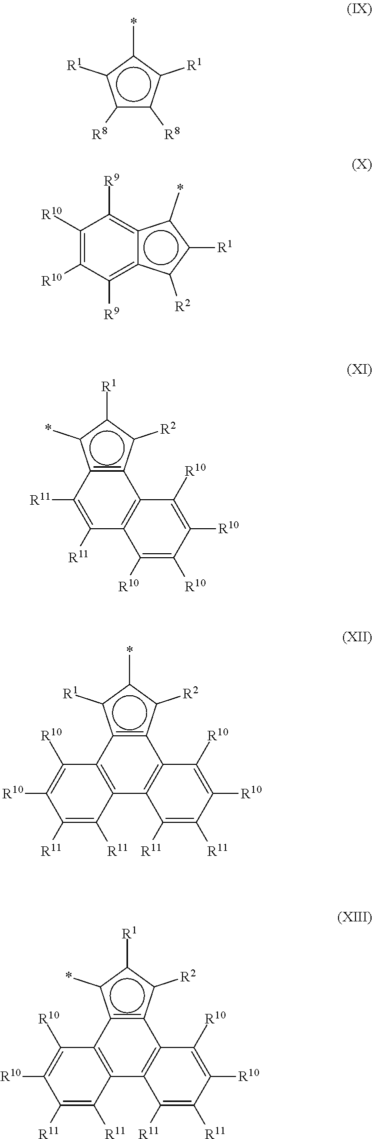

The symbol * indicates that, whether to a chemical bond, an atom, or a radical, the site can form a chemical single bond with a chemical bond, atom or radical of the same kind. Hereinafter, the symbol * in all cases have the same meaning.

In general chemical formulae (IX), (X), (XI), (XII) and (XIII):
R¹ is as defined above.
R¹ is preferably hydrogen, methyl, ethyl, isopropyl, t-butyl, phenyl, benzyl, 2-furyl, or 2-thienyl.
R² is hydrogen, fluoro, or R as defined above. R² is preferably hydrogen.
R⁸, being the same or different, is any one of the following: a saturated or unsaturated, halogenated or non-halogenated C₁-C₄₀ alkyl group, optionally including a heteroatom from Groups 13 to 17 in the periodic table, and C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.
R⁸ is preferably methyl, ethyl, isopropyl, t-butyl, or phenyl. Hereinafter, the R⁸ in all cases have the same meaning.
R⁹, being the same or different, is any one of the following: a saturated or unsaturated, halogenated or non-halogenated C₁-C₄₀ alkyl group, optionally including a heteroatom from Groups 13 to 17 in the periodic table, and C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R⁹ is preferably a straight or branched, saturated or unsaturated, partially or wholly halogenated, linear or cyclic C₁-C₂₀ carbon radical. Hereinafter, the R⁹ in all cases have the same meaning.

R¹⁰, being the same or different, is any one of the following: a saturated or unsaturated, halogenated or non-halogenated C₁-C₄₀ alkyl group, optionally including a heteroatom from Groups 13 to 17 in the periodic table, and C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R¹⁰ is preferably hydrogen, fluoro, chloro, methyl, ethyl, or phenyl. Hereinafter, the R¹⁰ in all cases have the same meaning.

R¹¹, being the same or different, and is any one of the following: hydrogen, fluoro, chloro, bromo, OR, SR, OCOR, NR₂ or PR₂, in which R is as defined above. Alternatively, R¹¹, being the same or different, is any one of the following: a saturated or unsaturated, halogenated or non-halogenated C₁-C₄₀ alkyl group, optionally including a heteroatom from Groups 13 to 17 in the periodic table, and C₃-C₄₀ cycloalkyl group, a C₆-C₄₀ aryl group, a Alkyl-substituted aryl group having 7 to 40 carbon atoms, or an aryl-substituted alkyl group having 7 to 40 carbon atoms. Examples of the C₁-C₄₀ saturated alkyl group and halogenated alkyl group include, but are not limited to, methyl, trifluoromethyl, ethyl, 1,1,1-trifluoroethyl, perfluoroethyl, n-propyl, isopropyl, n-butyl, i-butyl, t-butyl, n-pentyl, i-pentyl, n-hexyl, n-heptyl, n-octyl, n-dodecyl, n-octadecyl, trimethylsilyl, triethylsilyl, triphenylsilyl, and the like. Examples of the C₁-C₂₀ unsaturated alkyl group include, but are not limited to, vinyl, propenyl, allyl, and the like. Examples of the C₃-C₄₀ cycloalkyl group include, but are not limited to, cyclopropyl, cyclobutyl, cyclopentyl, cyclohexyl, cyclooctyl, 1-adamantanyl, and the like. Examples of the C₆-C₄₀ aryl group include, but are not limited to, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, and the like. Examples of the Alkyl-substituted aryl group having 7 to 40 carbon atoms include, but are not limited to, 2-methylphenyl, 2,6-dimethylphenyl, 2-fluoro-3-methylphenyl, 2-fluoro-4-methyl phenyl, 2,6-difluoro-3-methylphenyl, 2,6-difluoro-4-methylphenyl, 2-chloro-3-methylphenyl, 2-chloro-4-methylphenyl, 2,6-dichloro-3-methylphenyl, 2,6-dichloro-4-methylphenyl, 2-ethylphenyl, 2,6-diethylphenyl, 2-isopropylphenyl, 2,6-diisopropylphenyl, 3-methylphenyl, 3,5-dimethylphenyl, 3-fluoro-4-methylphenyl, 3,5-difluoro-4-methyl phenyl, 3,5-difluoro-4-ethylphenyl, 3,5-difluoro-4-isopropylphenyl, 3,5-difluoro-4-tert-butylphenyl, 3,5-difluoro-4-trimethylsilylphenyl, 3-trifluoromethylphenyl, 3,5-bis-trifluoromethyl-phenyl, 4-methylphenyl, 4-trifluoromethylphenyl, 4-ethylphenyl, 4-isopropylphenyl, 4-tert-butylphenyl, 4-trimethylsilylphenyl, and the like. Examples of the An aryl-substituted alkyl group having 7 to 40 carbon atoms include, but are not limited to, benzyl, p-methylbenzyl, p-fluorobenzyl, p-chlorobenzyl, p-ethylbenzyl, p-isopropylbenzyl, p-tert-butylbenzyl, p-trifluoromethylbenzyl, p-trimethylsilylbenzyl, 3,5-difluorobenzyl, 3,4,5-trifluorobenzyl, 3,5-bis-trimethylsilylbenzyl, 3,5-bis-trifluoromethylbenzyl, phenylethyl, p-methylphenylethyl, p-fluorophenylethyl, p-chlorophenylethyl, p-isopropylphenylethyl, p-tert-butylphenylethyl, p-trimethylsilylphenylethyl, 2,6-difluorophenylethyl, 3,5-difluorophenylethyl, 3,4,5-trifluorophenylethyl, perfluorophenylethyl, 1-naphthylmethyl, 2-naphthylmethyl, and the like.

R¹¹ is preferably hydrogen, fluoro, chloro, an ester group, an alkoxyl group, a mercapto group, an amino group or a phosphino group. Hereinafter, the R¹¹ in all cases have the same meaning.

In general chemical formula (I), A is a monovalent anionic π-ligand. Also, the precursor of A is a neutral stable organic compound having a chemical structure represented by general chemical formula (II):

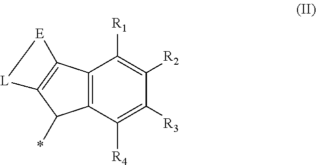

In the general chemical formula (II), R¹, R², R³, R⁴, L and E are as defined above. Further, the general chemical formula (II) comprises a basic cyclopentadienyl ring structure. The cyclopentadienyl structure has an active hydrogen which has specific electrophilic reactivity and may react with a nucleophilic agent such as a Grignard agent or an organolithium agent in an exchange reaction, and the basic reaction is shown by the general reaction equation:

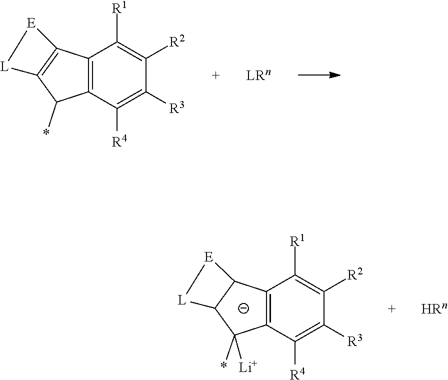

In the above general reaction equation, the nucleophilic agent is exemplified as an organolithium agent RⁿLi, but is not limited to the organolithium agent in practice. Rⁿ is a C₁—C₆ alkyl group or a C₆-C₁₂ aryl group.

Embodiments of the present disclosure relate to synthesis of the metallocene complex represented by general formula (I), comprising:

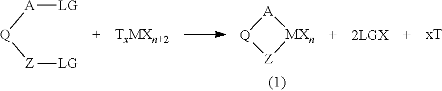

wherein, T, being the same as or different from each other, is a monodentate or bidentate neutral ligand;
LG is a leaving group, same as or different from each other, which is hydrogen, an alkali metal element, or an organic radical of heavy elements of Group 14.

Herein, the monodentate ligand includes ethers ROR, thioethers RSR, tertiary amines NR₃, tertiary phosphines PR₃, cyclic ethers, cyclic thioethers, ketones, substituted cyclic ketones, substituted pyridines, substituted pyrroles, substituted piperidines, esters, lactones, amides, lactams, and the like, wherein R is a straight or branched, saturated or unsaturated, halogenated or non-halogenated C₁-C₂₀ alkyl group, or a C₁-C₂₀ alkyl group including a heteroatom from Groups 13 to 17 in the periodic table, or a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms.

Herein, the bidentate ligand includes ortho-diethers, α,ω-diethers, ortho-diamines, α,ω-diamines, ortho-disulfides, α,ω-disulfides, ortho-bisphosphines, α,ω-bisphosphines, and the like. Herein, x is 0 or an integer of 1, 2 or 3.

Herein, the alkali metal element includes lithium, sodium, and potassium; the organic radical having a Group 14 heavy element includes SiR₃, GeR₃, SnR₃, PdR₃, ZnR, BaR, MgR and CaR, wherein R is a straight or branched, saturated or unsaturated, halogenated or non-halogenated C₁-C₂₀ alkyl group, or a C₁-C₂₀ alkyl group including a heteroatom from Groups 13 to 17 in the periodic table, or a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms.

Herein, in the synthesis process, the reaction medium is a saturated C₅-C₁₅ alkane, cycloalkane or a mixture of two or more thereof.

Herein, in the synthesis process, the reaction medium is hexane, heptane, octane, toluene, or xylene. Herein, the reaction temperature is in the range of −100° C. to +300° C.

Herein, the reaction temperature is in the range of −75° C. to +250° C.

Herein, the reaction temperature is in the range of −50° C. to +150° C.

The present disclosure relates to a preparation method of the fluorinated silica gel support, wherein the fluorinated silica gel support is prepared by reacting silica gel with fluoride and then heating the resultant under an oxygen and argon atmosphere.

Alternatively, the fluorinated silica gel support is prepared by reacting silica gel with fluoride and fatty alcohol and then heating the resultant under an oxygen and argon atmosphere.

Herein, preferably, the fluorinated silica gel support is prepared by reacting silica gel with fluoride and phenol and then heating the resultant under an oxygen and argon atmosphere.

Specifically, the preparation method of the fluorinated silica gel support comprises: dispersing dehydrated silica gel in an organic solvent at a dispersion temperature of −30° C. to 120° C.; at that temperature, contacting the dispersion with fluoride (or fluoride and fatty alcohol) for 0.5 to 10 h; filtering the solid and washing the resultant with the organic solvent and drying it; after that, heating the resultant under an oxygen atmosphere at 200 to 500° C. for 1 to 6 h, and then heating the resultant under an argon atmosphere at 200 to 500° C. for 1 to 6 h, to obtain the support.

Herein, the dehydration condition is vacuum at 200-700° C.

Herein, the organic solvent is toluene, hexane or heptane.

Herein, the fluoride is dialkylaluminum fluoride, preferably diethylaluminum fluoride, diisopropylaluminum fluoride or dibutylaluminum fluoride.

Herein, the fluoride is fed in a ratio of 1-100 mmol/g of the silica gel.

Herein, the weight/mole ratio of the support to the metallocene complex is 1-50 kg/mol.

An embodiment of the present disclosure relates to a preparation method of the catalyst composition, comprising: mixing the main catalyst with the fluorinated silica gel support in a homogeneous liquid medium for reaction, wherein the homogeneous liquid medium comprises a saturated alkane liquid medium and an aromatic liquid medium, the saturated alkane includes pentane and isomers thereof, hexane and isomers thereof, heptane and isomers thereof, as well as octanes and isomers thereof, and the aromatic liquid medium includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof.

An embodiment of the present disclosure further relates to catalyst composition for olefin polymerization comprising the main catalyst and fluorinated silica gel support and further comprising a Lewis acid substance LA.

Herein, LA is a polymethylaluminoxane or modified polymethylaluminoxane having simultaneously chain-, cyclic- and cage-like structures in equilibrium in a solution or an organic boron reagent.

LA is a Lewis acid substances, which is bulky, electron-delocalized, and has poor coordination capability. Representatives of these substances are polymethylaluminoxane (PMAO) having simultaneously chain, cyclic and cage-like structures in equilibrium in a solution, and the modified polymethylaluminoxane (MMAO) based thereon.

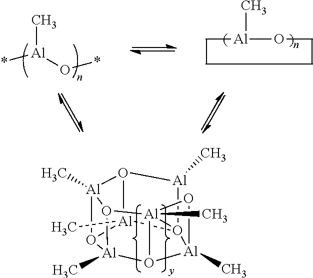

There are still a great number of examples of the anion which is bulky, electron-delocalized and has poor coordination capability according to the present disclosure, such as: [B(C₆H₅)₄]⁻, [(CH₃)B(C₆F₅)₃]⁻, [B(C₆F₅)₄]⁻, [B(2,6-(CH₃)₂—C₆H₃)₄]⁻, [B(2,4,6-(CH₃)₃—C₆H₂)₄]⁻, [B(2,3,5,6-(CH₃)₄—C₆H)₄]⁻, [B(2,6-(CF₃)₂—C₆H₃)₄]⁻, [B(2,4,6-(CF₃)₃—C₆H₂)₄]⁻, [B(2,3,5,6-(CF₃)₄—C₆H)₄]⁻, [B(3,5-(CH₃)₂—C₆H₃)₄]⁻, [B(3,4,5-(CH₃)₃—C₆H₂)₄]⁻, [B(3,5-(CF₃)₂—C₆H₃)₄]⁻, [B(3,4,5-(CF₃)₃—C₆H₂)₄]⁻, [B(2,6-(CF₃)₂—C₆F₃)₄]⁻, [B(2,4,6-(CF₃)₃—C₆F₂)₄]⁻, [B(2,3,5,6-(CF₃)₄—C₆F)₄]⁻, [B(3,5-(CF₃)₂—C₆F₃)₄]⁻, [B(3,4,5-(CF₃)₃—C₆F₂)₄]⁻, [Al(C₆H₅)₄]⁻, [(CH₃)Al(C₆F₅)₃]⁻, [Al(C₆F₅)₄]⁻, [Al(2,6-(CH₃)₂—C₆H₃)₄]⁻, [Al(2,4,6-(CH₃)₃—C₆H₂)₄]⁻, [Al(2,3,5,6-(CH₃)₄—C₆H)₄]⁻, [Al(3,5-(CH₃)₂—C₆H₃)₄]⁻, [Al(3,4,5-(CH₃)₃—C₆H₂)₄]⁻, [Al(2,6-(CH₃)₂—C₆F₃)₄]⁻, [Al(2,4,6-(CH₃)₃—C₆F₂)₄]⁻, [Al(2,3,5,6-(CH₃)₄—C₆F)₄]⁻, [Al(3,5-(CH₃)₂—C₆F₃)₄]⁻, [Al(3,4,5-(CH₃)₃—C₆F₂)₄]⁻, [Al(2,6-(CF₃)₂—C₆H₃)₄]⁻, [Al(2,4,6-(CF₃)₃—C₆H₂)₄]⁻, [Al(2,3,5,6-(CF₃)₄—C₆H)₄]⁻, [Al(3,5- (CF₃)₂—C₆H₃)₄]⁻, [Al(3,4,5-(CF₃)₃—C₆H₂)₄]⁻, [Al(2,6-(CF₃)₂—C₆F₃)₄]⁻, [Al(2,4,6-(CF₃)₃—C₆F₂)₄]⁻, [Al(2,3,5,6-(CF₃)₄—C₆F)₄]⁻, [Al(3,5-(CF₃)₂—C₆F₃)₄], [Al(3,4,5-(CF₃)₃—C₆F₂)₄]⁻, {t-Bu- CH═C[B(C₆F₅)₂]₂(CH₃)}⁻, {Ph-CH═C[B(C₆F₅)₂]₂(CH₃)}⁻, {(C₆F₅)—CH═C[B(C₆F₅)₂]₂(CH₃)}⁻, {t-Bu-CH═C[Al(C₆F₅)₂]₂(CH₃)}⁻, {Ph-CH═C[Al(C₆F₅)₂]₂(CH₃)}⁻, {(C₆F₅)—CH═C[Al(C₆F₅)₂]₂(CH₃)}⁻, [1,1′-C₁₂F₈-2,2′═B(C₆F₅)₂]⁻, [1,1′-C₁₂F₈-2,2′=Al(C₆F₅)₂]⁻, [FB (1-C₆F₄-2-C₆F₅)₃]⁻, [(CH₃)B(1-C₆F₄-2-C₆F₅)₃]⁻, [(C₆F₅)B(1-C₆F₄-2- C₆F₅)₃]⁻, [(C₆F₅)Al(1-C₆F₄-2—C₆F₅)₃]⁻, [FAl(1-C₆F₄-2-C₆F₅)₃]—, [(CH₃)Al(1-C₆F₄-2-C₆F₅)₃]—,]⁻, [HB(1-C₆F₄-2-C₆F₅)₃]⁻, [HAl(1-C₆F₄-2-C₆F₅)₃]⁻, [(CH₃)B(2-C₁₀F₇)₃]⁻, [(CH₃)Al(2-C₁₀F₇)₃]⁻, [(CH₃)B(p-C₆F₄SiMe₃)₃]⁻, [B(p-C₆F₄SiMe₃)₄]⁻, [(CH₃)B(p-C₆F₄Si(n-Bu)₃)₃]⁻, [B(p-C₆F₄Si(n-Bu)₃)₄]⁻, [(CH₃)B(p-C₆F₄Si(i-Bu)₃)₃]⁻, [B(p-C₆F₄Si(i-Bu)₃)₄]⁻, [(CH₃)B(p-C₆F₄Si(t-Bu)₃)₃]⁻, [B(p-C₆F₄Si(t- Bu)₃)₄]⁻, [(C₆F₅)₃B—C₆F₄—B(C₆F₅)₂]⁻, [C₆F₄-1,2-(B(C₆F₅)₃)₂]⁻, [C₆F₄-1,2- (Al(C₆F₅)₃)₂]⁻, [(C₆F₄)-1,2-(B(C₆F₅)₂)₂-1′,2′-(C₆F₄)]⁻, [(C₆F₄)-1,2-(Al(C₆F₅)₂)₂-1′,2′-(C₆F₄)]⁻, [(C₆F₅)₃B—CN—B(C₆F₅)₃]⁻, [(C₆F₅)₃Al—CN—Al(C₆F₅)₃]⁻, [((C₆F₅)₃BNC)₄Ni]⁻, [((C₆F₅)₃AlNC)₄Ni]⁻, [(1,1′-C₁₂F₈)₂-2,2′-B]⁻, [(1,1′-C₁₂F₈)₂-2,2′-Al]⁻, [B(O—C₆F₅)₄]⁻, [Al(O—C₆F₅)₄]⁻, [(C₆F₅)₃Al—C₆F₄—Al(C₆F₅)₂]⁻, [(CH₃)Al(p-C₆F₄SiMe₃)₃]⁻, [Al(p-C₆F₄SiMe₃)₄]⁻, [(CH₃)Al(p-C₆F₄Si(n-Bu)₃)₃]⁻, [Al(p-C₆F₄Si(n-Bu)₃)₄]⁻, [(CH₃)Al(p-C₆F₄Si(i-Bu)₃)₃]⁻, [Al(p-C₆F₄Si(i-Bu)₃)₄]⁻, [(CH₃)Al(p-C₆F₄Si(t-Bu)₃)₃]⁻, [Al(p-C₆F₄Si(t-Bu)₃)₄]⁻, [C₅(C₆H₅)₅]⁻, [C₅(2,6-(CH₃)₂—C₆H₃)₅]⁻, [C₅(2,4,6-(CH₃)₃—C₆H₂)₅]⁻, [C₅(3,5-(CH₃)₂—C₆H₃)₅]⁻, [C₅(3,4,5-(CH₃)₃—C₆H₂)₅]⁻, [C₅(2,6-(CF₃)₂—C₆H₃)₅]⁻, [C₅(2,4,6-(CF₃)₃—C₆H₂)₅]⁻, [C₅(3,5-(CF₃)₂—C₆H₃)₅]⁻, [C₅(3,4,5-(CF₃)₃—C₆H₂)₅]⁻, [C₅(2,6-(CH₃)₂—C₆F₃)₅]⁻, [C₅(2,4,6-(CH₃)₃—C₆F₂)₅]⁻, [C₅(3,5-(CH₃)₂—C₆F₃)₅]⁻, [C₅(3,4,5-(CH₃)₃—C₆F₂)₅]⁻, [C₅(2,6-(CF₃)₂—C₆F₃)₅]⁻, [C₅(2,4,6-(CF₃)₃—C₆F₂)₅]⁻, [C₅(3,5-(CF₃)₂—C₆F₃)₅]⁻, [C₅(3,4,5-(CF₃)₃—C₆F₂)₅]⁻, [C₅(C₆F₅)₅]⁻, [Li(Ta(OC₆F₅)₄(2-OC₆F₅)₂)₂]⁻, [Nb(OC₆F₅)₆]⁻, [PF₆]⁻, [AsF₆]⁻, [SbF₆]⁻, [BF₄]⁻, [ClO₄]⁻; and carborane anions such as [C₂B₉H₁₂]⁻ and [CB₁₁H₁₂]⁻, but are not limited thereto.

Herein, the mole ratio of the LA to the metallocene complex is 100-300.

An embodiment of the present disclosure relates to a preparation method of the catalyst composition for olefin polymerization, comprising: mixing the main catalyst with the fluorinated silica gel support and the Lewis acid substance LA in a homogeneous liquid medium in an arbitrary order for reaction, wherein the homogeneous liquid medium comprises a saturated alkane liquid medium and an aromatic liquid medium, the saturated alkane includes pentane and isomers thereof, hexane and isomers thereof, heptane and isomers thereof, as well as octanes and isomers thereof, and the aromatic liquid medium includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof.

Herein, the reaction temperature is in the range of −75° C. to 150° C.

Herein, the reaction time is in the range of 1 min to 8 h.

An embodiment of the present disclosure further relates to the use of the catalyst composition in the polymerization of an olefin CH2=CHR, wherein R is hydrogen or a hydrocarbon group containing 1-12 carbon atoms.

Herein, the olefin is selected from ethylene, propylene, 1-butene, 1-pentene, 1-hexene, 4-methyl-1-pentene, 1-heptene, 1-nonene, 1-decene, 3-methyl-1-butene, 4-methyl-1-pentene, butadiene, hexadiene, vinylcyclopentene, and vinylcyclohexene.

The use of the metallocene catalyst composition for olefin polymerization in the embodiment of the present disclosure is generally applicable to the bulk slurry polymerization process. It may also be suitable for solvent slurry polymerization or gas phase polymerization processes with appropriate polymerization conditions and catalyst adjustments.

The fluorinated silica gel support is used to support the metallocene complex described in the present disclosure to change the homogeneous catalytic system into a non-homogeneous catalytic system, which further improves the morphology of polymer product, increases the packing density and flowability of the product, and can largely avoid clogging of the polymerization unit. In addition, the fluorinated silica gel provides sufficient acidic sites. Compared to the use of ordinary silica-loaded catalysts, the amount of expensive methylaluminoxane or borate reagent activators can be significantly reduced while maintaining the same activity level, and high activity can be achieved even without the use of methylaluminoxane or borate reagent activators. Moreover, the effective life of the catalyst can be extended, which reduces the production cost while improving the catalytic performance, which is conducive to the promotion of industrial applications.

As can be seen from Table 2, Comparative Example 5, not using a support, had poor polymer fluidity and agglomeration, making it impossible to measure the packing density; and the use of a fluorinated silica gel support improved the polymer morphology and increased the packing density. As shown in Examples 1 to 4, the polymerization activity when using a fluorinated silica gel support without methylaluminoxane (MAO) is at a comparable or slightly higher level compared to the activities of Comparative Examples 1˜4 when using a normal silica gel support and an methylaluminoxane additive up to 500 folds. The catalyst activities of Examples 34 to 37 using the fluorinated silica gel support together with only 100 folds of MAO and Examples 42 to 45 using the fluorinated silica gel support together with only 60 folds of MAO were higher than those of the Comparative Examples 1 to 4. This indicates that a catalyst composition using the fluorinated silica gel support can substantially reduce the amount of MAO or avoid the use of MAO while maintaining high catalytic performance. As shown in Examples 1 to 45, the catalyst composition of the present disclosure has high polymerization activity within a polymerization time of 1 h, adjustable isotacticity, and the polymer has a high packing density and good morphology.

### DETAILED DESCRIPTION OF THE DISCLOSURE

The following examples of the present disclosure are described in detail: the present examples are implemented under the premise of the technical solution of the present disclosure, and detailed implementation methods and processes are given. However, the protection scope of the present disclosure is not limited to the following examples. The process parameters in the following examples for which specific conditions are not indicated are generally in accordance with conventional conditions.

None of the endpoints of the ranges nor any of the values disclosed in the present disclosure shall be limited to that precise ranges or values, and these ranges or values shall be understood to include values close to those ranges or values. For numerical ranges, combinations may be made between the endpoint values of the individual ranges, between the endpoint values of the individual ranges and the individual point values, and between the individual point values, to obtain one or more new numerical ranges. These numerical ranges shall be deemed to be specifically disclosed in the present disclosure.

The methods for analysis and characterization used in the related techniques of the present disclosure are as follows:

The ligands and complexes are analyzed by NMR and mass spectrometry.
NMR: AV400, BRUKER, Germany
Mass Spectrometer: 5973N, Agilent, USA

### Example 1

### (1) Synthesis of Metallocene Complex Cat-1:

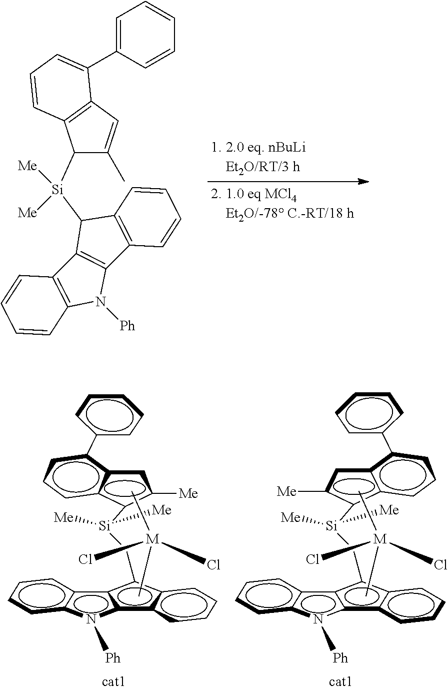

In the above reaction formula, M is Zr, and the specific synthesis steps are described in Example 1 of CN105985368A.

### (2) Preparation of Fluorinated Silica Gel Support S1

The Grace 955 model silica gel was vacuumized at 450° C. for 3 h and then naturally cooled to room temperature under inert gas protection. 5 g of the dehydrated silica gel was added to a 500 mL three-necked flask containing 250 mL of hexane, and 15 mL of 1 M AlEt₂F solution in toluene was added at room temperature and stirred for 2 h. The mixture was filtered and washed with hexane and vacuumized. The support obtained was heated from room temperature to 150° C. in 1 h and maintained for 1 h, then heated up to 450° C. and maintained for another 3 h, and naturally cooled to room temperature. During the process of this temperature change, the support was kept fluidized in oxygen, and then fluidized in argon at 200° C. for 2 h, to obtain the fluorinated silica gel support S1.

### (3) Preparation of Catalyst Composition CSC-1

The metallocene complex Cat-1 was dissolved in toluene to prepare a solution with a concentration of 10 mM. 50 mg of the fluorinated silica gel support S1 was added to a 50 mL flask containing 20 mL of hexane, and 3 mL of triisobutylaluminum-hexane solution at a concentration of 1 M was added thereto. After stirring for 5 min, 1 mL of the above prepared Cat-1 solution in toluene (10 mM) was added and stirred at room temperature for 30 min, to obtain the catalyst composition CS-1.

### (4) Polymerization

A 5 L reaction kettle was vacuumized and replaced by nitrogen for 3 times, and then 1000 μmol of triisobutylaluminum and 1000 g of propylene were added to the reaction kettle. The catalyst composition solution prepared in step (3) was pressed into the reaction kettle with high pressure nitrogen. The temperature was raised to 70° C., and the polymerization reaction was carried out for 1 h. 182 g of polymerization product was obtained, with a catalyst activity of 1.82×10⁷ gPP/molcat·h, an isotacticity of 86%, and a packing density of 0.382 g/mL.

### Examples 2 to 33

(1) Synthesis of metallocene complexes Cat-1 to Cat-33: The steps were the same as in Example 1, except that the raw materials were replaced with ligand raw materials with corresponding substituents. The substituents of catalyst complexes are shown in Table 1.
(2) Preparation of fluorinated silica gel support S1: Same as Example 1.
(3) Preparation of catalyst compositions CSC-1 to CSC-33: Same as Example 1, except that Cat-1 was replaced with Cat-2 to Cat-33 respectively.
(4) Polymerization: The polymerization conditions were the same as Example 1. The polymerization properties are shown in Table 2.

### Examples 34 to 37

(1) As metallocene complexes, Cat-1 to Cat-4 were used.
(2) Preparation of fluorinated silica gel support S1: Same as Example 1.
(3) Preparation of catalyst compositions CSC-34 to CSC-37.

The metallocene complex Cat-1 was dissolved in toluene to prepare a solution with a concentration of 10 mM. 50 mg of the fluorinated silica gel support S1 was added to a 50 mL flask containing 20 mL of hexane, and 1000 μmol of MAO (methylaluminoxane) solution was added. After stirring for 5 min, 1 mL of the above prepared Cat-1 to Cat-4 solution in toluene (10 mM) was added and stirred at room temperature for 30 min, to obtain the catalyst composition CS-34 to CSC-37.
(4) Polymerization: The polymerization conditions were the same as Example 1. The polymerization properties are shown in Table 2.

### Examples 38 to 41

(1) As metallocene complexes, Cat-1 to Cat-4 were used.
(2) Preparation of fluorinated silica gel support S2

The Grace 955 model silica gel was vacuumized at 450° C. for 3 h and then naturally cooled to room temperature under inert gas protection. 5 g of the dehydrated silica gel was added to a 500 mL three-necked flask containing 250 mL of hexane, and 20 mL of 1 M AlEt₂F solution in toluene and 3 mmol of ethanol were added at room temperature and stirred for 2 h. The mixture was filtered and washed with hexane and vacuumized. The support obtained was heated from room temperature to 100° C. in 1 h and maintained for 1 h, then heated up to 400° C. and maintained for another 3 h, and naturally cooled to room temperature. During the process of this temperature change, the support was kept fluidized in oxygen, to obtain the fluorinated silica gel support S2.
(3) Preparation of catalyst compositions CSC-38 to CSC-41: Same as Example 1, except that S1 was replaced with S2.
(4) Polymerization: The polymerization conditions were the same as Example 1. The polymerization properties are shown in Table 2.

### Examples 42 to 45

(1) As metallocene complexes, Cat-1 to Cat-4 were used.
(2) Preparation of fluorinated silica gel support S2: Same as Example 38.
(3) Preparation of catalyst compositions CSC-42 to CSC-45.

Each of the metallocene complexes Cat-1 to Cat-4 was dissolved in toluene to prepare a solution with a concentration of 10 mM. 50 mg of the fluorinated silica gel support S2 was added to a 50 mL flask containing 20 mL of hexane, and 600 μmol of MAO (methylaluminoxane) solution was added. After stirring for 5 min, 1 mL of the above prepared Cat-1 solution in toluene (10 mM) was added and stirred at room temperature for 30 min, to obtain the catalyst composition CSC-42 to CSC-45.
(4) Polymerization: The polymerization conditions were the same as Example 1. The polymerization properties are shown in Table 2.

### Comparative Examples 1 to 4

(1) As metallocene complexes, Cat-1 to Cat-4 were used.
(2) Activation of silica gel support S0.

The Grace 955 model silica gel was vacuumized at 450° C. for 3 h and then naturally cooled to room temperature under inert gas protection.
(3) Preparation of catalyst compositions D1 to D4.

Each of the metallocene complexes Cat-1 to Cat-4 was dissolved in toluene to prepare a solution with a concentration of 10 mM. 50 mg of the activated Grace-955 model silica gel from step (2) was added to a 50 mL flask containing 20 mL of hexane, and 5000 μmol of MAO (methylaluminoxane) solution was added. After stirring for 5 min, 1 mL of the above prepared Cat-1 to Cat-4 solution in toluene (10 mM) was added and stirred at room temperature for 30 min, to obtain the catalyst composition D-1 to D-4.
(4) Polymerization: The polymerization conditions were the same as Example 1. The polymerization properties are shown in Table 2.

### Comparative Example 5

(1) As metallocene complex, Cat-1 was used.
(2) Preparation of catalyst composition D5

The metallocene complex Cat-1 was dissolved in toluene to prepare a solution with a concentration of 10 mM. 1 mL of Cat-1 solution in toluene was added to 5000 μmol of MAO (methylaluminoxane) solution, to obtain the catalyst composition D5.
(3) Polymerization: The polymerization conditions were the same as Example 1. The polymerization properties are shown in Table 2.

As can be seen from Table 2, Comparative Example 5 not using a support, had poor polymer fluidity and agglomeration, making it impossible to measure the packing density; and the use of a fluorinated silica gel support improved the polymer morphology and increased the packing density. As shown in Examples 1 to 4, the polymerization activity when using a fluorinated silica gel support without methylaluminoxane (MAO) is at a comparable or slightly higher level compared to the activities of Comparative Examples 1˜4 when using a normal silica gel support and an methylaluminoxane additive up to 500 folds. The catalyst activities of Examples 34 to 37 using the fluorinated silica gel support with together only 100 folds of MAO and Examples 42 to 45 using the fluorinated silica gel support together with only 60 folds of MAO were higher than those of the Comparative Examples 1 to 4. This indicates that a catalyst composition using the fluorinated silica gel support can substantially reduce the amount of MAO or avoid the use of MAO while maintaining high catalytic performance. As shown in Examples 1 to 45, the catalyst composition of the present disclosure has high polymerization activity within a polymerization time of 1 h, adjustable isotacticity, and polymer has a high packing density and good morphology.

| | Formula | Formula | | Formula | | | | | | | | |
|---|---|---|---|---|---|---|---|---|---|---|---|---|
| No. | Z | A | E | L | M | X | Q | R¹ | R² | R³ | R⁴ | R⁵ |
| Cat-1 | (X) | (II) | NPh | (V) | Zr | Cl | SiMe₂ | H | H | H | H | — |
| Cat-2 | (X) | (II) | NPh | (V) | Zr | Cl | SiMe₂ | H | H | H | H | — |
| Cat-3 | (X) | (II) | NPh | (V) | Zr | Cl | SiMe₂ | H | H | H | H | — |
| Cat-4 | (X) | (II) | NPh | (V) | Zr | Cl | SiMe₂ | H | H | H | H | — |
| Cat-5 | (X) | (II) | NPh | (V) | Zr | Cl | CMe₂ | H | H | H | H | — |
| Cat-6 | (X) | (II) | NPh | (V) | Zr | Cl | CMe₂ | H | H | H | H | — |
| Cat-7 | (X) | (II) | NPh | (V) | Zr | Cl | CMe₂ | H | H | H | H | — |
| Cat-8 | (IX) | (II) | NPh | (V) | Zr | Cl | SiMe₂ | H | H | H | H | — |
| Cat-9 | (XI) | (II) | NPh | (V) | Zr | Cl | SiMe₂ | H | H | H | H | — |
| Cat-10 | (XII) | (II) | NPh | (V) | Zr | Cl | SiMe₂ | H | H | H | H | — |
| Cat-11 | (XIII) | (II) | NPh | (V) | Zr | Cl | SiMe₂ | H | H | H | H | — |
| Cat-12 | (XI) | (II) | NPh | (III) | Zr | Cl | SiMe₂ | H | H | H | H | H |
| Cat-13 | (XI) | (II) | NPh | (IV) | Zr | Cl | SiMe₂ | H | H | H | H | H |
| Cat-14 | (XI) | (II) | NPh | (VI) | Zr | Cl | SiMe₂ | H | H | H | H | — |
| Cat-15 | (XI) | (II) | NPh | (VII) | Zr | Cl | SiMe₂ | H | H | H | H | — |
| Cat-16 | (XI) | (II) | NPh | (VIII) | Zr | Cl | SiMe₂ | H | H | H | H | — |
| Cat-17 | (IX) | (II) | NPh | (V) | Ti | Cl | SiMe₂ | H | H | H | H | — |
| Cat-18 | (IX) | (II) | NPh | (V) | Ti | Cl | CMe₂ | H | H | H | H | — |
| Cat-19 | (IX) | (II) | NPh | (V) | Hf | Cl | SiMe₂ | H | H | H | H | — |
| Cat-20 | (IX) | (II) | NPh | (V) | Y | Cl | SiMe₂ | H | H | H | H | — |
| Cat-21 | (IX) | (II) | NPh | (V) | V | Cl | SiMe₂ | H | H | H | H | — |
| Cat-22 | (IX) | (II) | NPh | (V) | Cr | Cl | SiMe₂ | H | H | H | H | — |
| Cat-23 | (X) | (II) | NPh | (V) | Zr | OMe | SiMe₂ | H | H | H | H | — |
| Cat-24 | (X) | (II) | NPh | (V) | Zr | Me | SiMe₂ | H | H | H | H | — |
| Cat-25 | (X) | (II) | NPh | (V) | Zr | OCOEt | SiMe₂ | H | H | H | H | — |
| Cat-26 | (X) | (II) | NPh | (V) | Ti | Cl | NPh | H | H | H | H | — |
| Cat-27 | (X) | (II) | NPh | (VII) | Ti | Cl | PPh | H | H | H | H | — |
| Cat-28 | (X) | (II) | PPh | (VII) | Ti | Cl | SiMe₂ | H | Me | H | H | — |
| Cat-29 | (X) | (II) | O | (V) | Ti | Cl | SiMe₂ | H | H | H | H | — |
| Cat-30 | (X) | (II) | S | (V) | Ti | Cl | SiMe₂ | H | H | H | H | — |
| Cat-31 | (X) | (II) | NPh | (V) | Zr | H | SiMe₂ | H | H | H | H | — |
| Cat-32 | (II) | (II) | NPh | (V) | Zr | Cl | SiMe₂ | H | H | H | H | — |
| Cat-33 | (II) | (II) | NPh | (V) | Zr | Cl | CMe₂ | H | H | H | H | — |

| No. | R⁶ | R⁷ | R⁸ | R⁹ | R⁹′ | R¹⁰ | R¹⁰′ | R¹¹ | R¹¹′ | R¹² | R¹³ |
|---|---|---|---|---|---|---|---|---|---|---|---|
| Cat-1 | H | — | — | Ph | H | H | H | — | — | Me | H |
| Cat-2 | H | — | — | m-OMePh | H | H | H | — | — | Me | H |
| Cat-3 | H | — | — | m-ClPh | H | H | H | — | — | Me | H |
| Cat-4 | H | — | — | p-′BuPh | H | H | H | — | — | Me | H |
| Cat-5 | H | — | — | C₄H₃O— | H | H | H | — | — | Me | H |
| Cat-6 | H | — | — | C₃H₃N₂— | H | H | H | — | — | Me | H |
| Cat-7 | H | — | — | m-CF₃Ph | H | H | H | — | — | Me | H |
| Cat-8 | H | — | Me | — | — | — | — | — | — | Me | — |
| Cat-9 | H | — | — | — | — | H | — | H | — | H | H |
| Cat-10 | H | — | — | — | — | H | H | H | H | H | H |
| Cat-11 | H | — | — | — | — | H | H | H | H | H | H |
| Cat-12 | — | — | — | — | — | H | — | H | — | H | H |
| Cat-13 | — | — | — | — | — | H | — | H | — | H | H |
| Cat-14 | H | H | — | — | — | H | — | H | — | H | H |
| Cat-15 | H | H | — | — | — | H | — | H | — | H | H |
| Cat-16 | H | H | — | — | — | H | — | H | — | H | H |
| Cat-17 | H | — | Me | — | — | — | — | — | — | Me | — |
| Cat-18 | H | — | Bu | — | — | — | — | — | — | Me | — |
| Cat-19 | H | — | Me | — | — | — | — | — | — | Me | — |
| Cat-20 | H | — | Me | — | — | — | — | — | — | Me | — |
| Cat-21 | H | — | Me | — | — | — | — | — | — | Me | — |
| Cat-22 | H | — | Me | — | — | — | — | — | — | Me | — |
| Cat-23 | H | — | — | m-FPh | H | H | H | — | — | Me | H |
| Cat-24 | H | — | — | p-CF₃OPh | H | H | H | — | — | Me | H |
| Cat-25 | H | — | — | m-CF₃Ph | H | H | H | — | — | Me | H |
| Cat-26 | H | — | — | m-NO₂Ph | H | H | H | — | — | Et | H |
| Cat-27 | H | H | — | m-NCPh | H | H | H | — | — | Me | H |
| Cat-28 | H | H | — | p-FPh | H | H | H | — | — | Me | H |
| Cat-29 | H | — | — | o-ClPh | H | H | H | — | — | Me | H |
| Cat-30 | H | — | — | 3,5-(CF₃)₂Ph | H | H | H | — | — | Me | H |
| Cat-31 | H | — | — | Ph | H | H | H | — | — | Me | H |
| Cat-32 | H | — | Me | — | — | — | — | — | — | Me | — |
| Cat-33 | H | — | Me | — | — | — | — | — | — | Me | — |

TABLE 2

| | | fluorinated | MAO/M | | activity | | Packing |
|---|---|---|---|---|---|---|---|
| | metallocene | silica gel | (molar | catalyst | (10⁷ gPP/ | isotacticity | density |
| Example | complex | support | ratio) | composition | molcat · h) | (%) | (g/mL) |
| 1 | Cat-1 | S1 | 0 | CSC-1 | 1.82 | 86 | 0.382 |
| 2 | Cat-2 | S1 | 0 | CSC-2 | 1.03 | 88 | 0.369 |
| 3 | Cat-3 | S1 | 0 | CSC-3 | 5.67 | 87 | 0.377 |
| 4 | Cat-4 | S1 | 0 | CSC-4 | 11.20 | 80 | 0.362 |
| 5 | Cat-5 | S1 | 0 | CSC-5 | 1.39 | 85 | 0.359 |
| 6 | Cat-6 | S1 | 0 | CSC-6 | 2.71 | 86 | 0.374 |
| 7 | Cat-7 | S1 | 0 | CSC-7 | 7.44 | 87 | 0.369 |
| 8 | Cat-8 | S1 | 0 | CSC-8 | 2.21 | 85 | 0.348 |
| 9 | Cat-9 | S1 | 0 | CSC-9 | 1.87 | 85 | 0.358 |
| 10 | Cat-10 | S1 | 0 | CSC-10 | 0.97 | 69 | 0.355 |
| 11 | Cat-11 | S1 | 0 | CSC-11 | 1.39 | 87 | 0.375 |
| 12 | Cat-12 | S1 | 0 | CSC-12 | 2.41 | 82 | 0.380 |
| 13 | Cat-13 | S1 | 0 | CSC-13 | 1.62 | 84 | 0.366 |
| 14 | Cat-14 | S1 | 0 | CSC-14 | 1.93 | 62 | 0.373 |
| 15 | Cat-15 | S1 | 0 | CSC-15 | 4.15 | 86 | 0.369 |
| 16 | Cat-16 | S1 | 0 | CSC-16 | 1.50 | 79 | 0.362 |
| 17 | Cat-17 | S1 | 0 | CSC-17 | 0.81 | 74 | 0.370 |
| 18 | Cat-18 | S1 | 0 | CSC-18 | 6.22 | 80 | 0.371 |
| 19 | Cat-19 | S1 | 0 | CSC-19 | 4.37 | 84 | 0.366 |
| 20 | Cat-20 | S1 | 0 | CSC-20 | 0.33 | 86 | 0.350 |
| 21 | Cat-21 | S1 | 0 | CSC-21 | 0.19 | 83 | 0.358 |
| 22 | Cat-22 | S1 | 0 | CSC-22 | 1.20 | 85 | 0.361 |
| 23 | Cat-23 | S1 | 0 | CSC-23 | 0.58 | 81 | 0.365 |
| 24 | Cat-24 | S1 | 0 | CSC-24 | 10.17 | 83 | 0.366 |
| 25 | Cat-25 | S1 | 0 | CSC-25 | 18.21 | 67 | 0.378 |
| 26 | Cat-26 | S1 | 0 | CSC-26 | 0.87 | 86 | 0.363 |
| 27 | Cat-27 | S1 | 0 | CSC-27 | 0.88 | 89 | 0.357 |
| 28 | Cat-28 | S1 | 0 | CSC-28 | 4.26 | 83 | 0.371 |
| 29 | Cat-29 | S1 | 0 | CSC-29 | 3.21 | 85 | 0.363 |
| 30 | Cat-30 | S1 | 0 | CSC-30 | 23.54 | 73 | 0.359 |
| 31 | Cat-31 | S1 | 0 | CSC-31 | 4.79 | 79 | 0.360 |
| 32 | Cat-32 | S1 | 0 | CSC-32 | 2.15 | 82 | 0.355 |
| 33 | Cat-33 | S1 | 0 | CSC-33 | 2.77 | 77 | 0.371 |
| 34 | Cat-1 | S1 | 100 | CSC-34 | 3.74 | 88 | 0.372 |
| 35 | Cat-2 | S1 | 100 | CSC-35 | 3.88 | 85 | 0.370 |
| 36 | Cat-3 | S1 | 100 | CSC-36 | 10.53 | 83 | 0.358 |
| 37 | Cat-4 | S1 | 100 | CSC-37 | 26.57 | 86 | 0.367 |
| 38 | Cat-1 | S2 | 0 | CSC-38 | 2.96 | 82 | 0.379 |
| 39 | Cat-2 | S2 | 0 | CSC-39 | 2.58 | 87 | 0.361 |
| 40 | Cat-3 | S2 | 0 | CSC-40 | 8.63 | 83 | 0.357 |
| 41 | Cat-4 | S2 | 0 | CSC-41 | 20.6 | 80 | 0.352 |
| 42 | Cat-1 | S2 | 60 | CSC-42 | 2.27 | 77 | 0.360 |
| 43 | Cat-2 | S2 | 60 | CSC-43 | 2.33 | 83 | 0.355 |
| 44 | Cat-3 | S2 | 60 | CSC-44 | 8.16 | 82 | 0.364 |
| 45 | Cat-4 | S2 | 60 | CSC-45 | 15.08 | 81 | 0.377 |
| Comparative | Cat-1 | S0 | 500 | D1 | 1.73 | 87 | 0.371 |
| Example1 | | | | | | | |
| Comparative | Cat-2 | S0 | 500 | D2 | 1.12 | 88 | 0.362 |
| Example2 | | | | | | | |
| Comparative | Cat-3 | S0 | 500 | D3 | 5.37 | 83 | 0.355 |
| Example3 | | | | | | | |
| Comparative | Cat-4 | S0 | 500 | D4 | 10.8 | 81 | 0.356 |
| Example4 | | | | | | | |
| Comparative | Cat-1 | [symbol] | 500 | D5 | 1.92 | 83 | — |
| Example5 | | | | | | | |

The above examples are only better and feasible embodiments of the present disclosure, and are not intended to limit the protection scope of the present disclosure, and the various deformations or applications in accordance with the above examples are within the protection scope of the technical solutions.

Although specific embodiments of the present disclosure have been described in detail, a person skilled in the art would understand that various modifications and replacements can be made to those details in accordance with all the teachings that have been disclosed, and all the changes are within the protection scope of the present disclosure. The full scope of the present disclosure is given by the appended claims and any equivalents thereof.

1. A catalyst composition for olefin polymerization, comprising a main catalyst and a support, wherein the support is fluorinated silica gel particles, and the main catalyst is a metallocene complex represented by general formula (I): 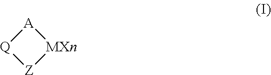
wherein M is a transition metal element from Group 3, Group 4, Group 5 and Group 6 in the periodic table, including elements of lanthanides and actinides;
Xs, being the same or different from each other, are selected from hydrogen, halogen, an alkyl group R, an alkoxyl group OR, a mercapto group SR, a carboxyl group OCOR, an amino group NR₂, a phosphino group PR₂, —OR^{o}O— and OSO₂CF₃; R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms; R^{o} is a divalent radical, including a C₂-C₄₀ alkylene group, a C₆-C₃₀ arylene group, an alkyl-substituted arylene group having 7 to 40 carbon atoms, or an aryl-substituted alkylene group having 7 to 40 carbon atoms; in the structure of —OR^{o}O—, the two oxygen atoms are located at any positions in the radical, respectively;
n is an integer from 1 to 4; the total charge number of the n Xs equals to the charge number of M minus 2;
Q is a divalent radical, including ═CR′₂, ═SiR′₂, ═GeR′₂, ═NR′, ═PR′, ═BR′, wherein R's, being the same or different, are a straight or branched C₁-C₂₀ alkyl group, a saturated or unsaturated C₁-C₂₀ alkyl group, a halogenated or non-halogenated C₁-C₂₀ alkyl group, a C₁-C₂₀ alkyl group optionally including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
A is a π-ligand having a structure represented by chemical formula (II): 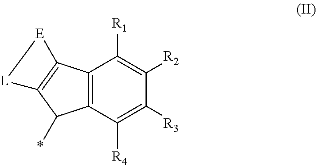
E is a biradical of an element of Group 15 or 16 in the periodic table, including an oxygen radical, a sulfur radical, a selenium radical, NR″ or PR″; wherein R″ is a straight or branched C₁-C₂₀ alkyl group, a saturated or unsaturated C₁-C₂₀ alkyl group, a halogenated or non-halogenated C₁-C₂₀ alkyl group, a C₁-C₂₀ alkyl group optionally including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
L is a divalent radical having a structure represented by the chemical formula (III), (IV), (V), (VI), (VII) or (VIII): 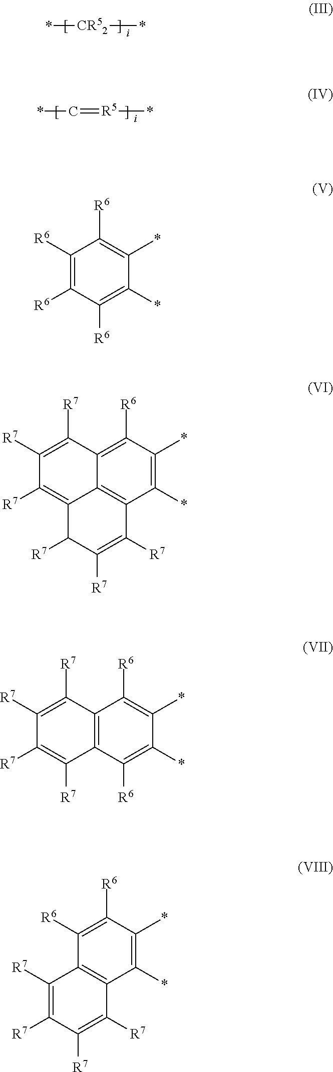
wherein i is 2;
Z is a π-ligand, wherein Z=A, or Z has a chemical structure represented by the following chemical formula (IX), (X), (XI), (XII) or (XIII): 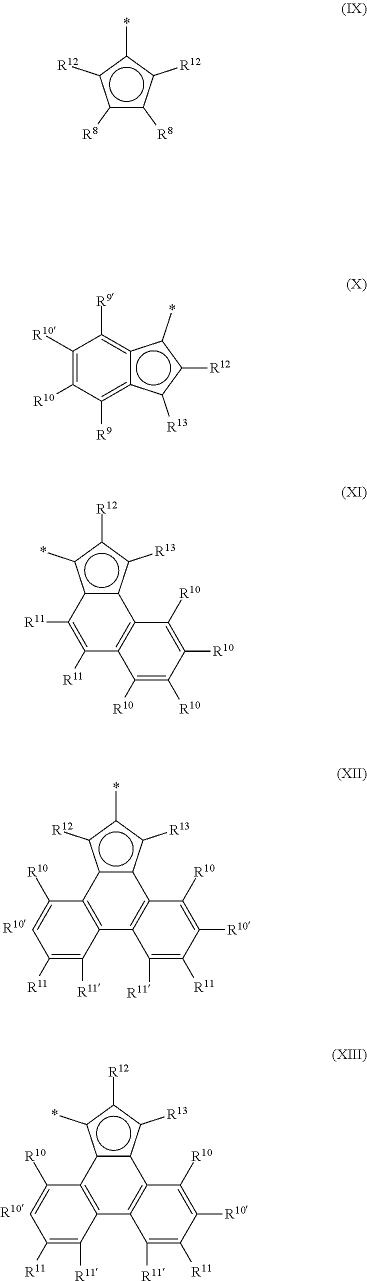
wherein R¹ is any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R¹² are hydrogen, methyl, ethyl, isopropyl, t-butyl, phenyl, benzyl, 2-furyl, or 2-thienyl;
R², R³ and R¹³ are each independently hydrogen, fluoro, or R, wherein R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆—C₃₀ aryl group, an alkyl-substituted aryl group having 7 to 30 carbon atoms, or an aryl-substituted alkyl group having 7 to 30 carbon atoms;
R⁴ is any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R⁵s, being the same or different, are any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R⁶ and R⁷ are each independently hydrogen, fluoro, or R, wherein R is a straight or branched C1-C20 alkyl group, a saturated or unsaturated C1-C20 alkyl group, a halogenated or non-halogenated C1-C20 alkyl group, a C₁-C₂₀ alkyl group including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
R⁸s, being the same or different, are any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R⁹ and R⁹′, being the same or different, are any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R¹⁰ and R¹⁰′, being the same or different, are any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms;
R¹¹ and R¹¹′, being the same or different, and is any one selected from: hydrogen, fluoro, chloro, bromo, OR, SR, OCOR, NR₂ or PR₂; or R¹¹s, being the same or different, is any one selected from: a saturated or unsaturated C₁-C₄₀ alkyl group, a halogenated or non-halogenated C₁-C₄₀ alkyl group, a C₁-C₄₀ alkyl group optionally including a heteroatom from Groups 13 to 17 in the periodic table, a C₃-C₄₀ cycloalkyl group, a C₆-C₄₀ aryl group, an alkyl-substituted aryl group having 7 to 40 carbon atoms, or an aryl-substituted alkyl group having 7 to 40 carbon atoms.

2. The catalyst composition for olefin polymerization according to claim 1, wherein A is a monovalent anionic π-ligand having a chemical structure represented by chemical formula (II)—Li⁺; chemical formula (II) includes a basic structure having a cyclopentadienyl ring, while the active hydrogen in the cyclopentadienyl structure has electrophilic reactivity and can react with a nucleophilic agent in an exchange reaction to produce the compound represented by chemical formula (II)—Li⁺, and the basic reaction thereof is shown as: 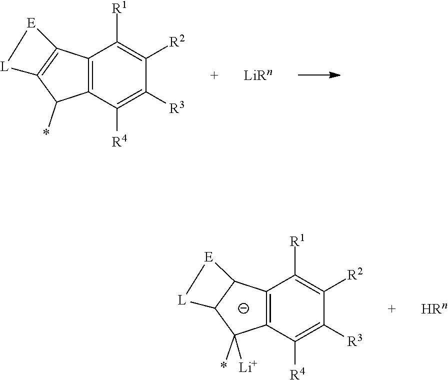
wherein the nucleophilic agent in the reaction is an organolithium agent LiRⁿ, wherein Rⁿ is a C₁-C₆ alkyl group or a C₆-C₁₂ aryl group; and wherein the symbol * connecting to a chemical bond, an atom, or a radical indicates that the site linked to * forms a chemical single bond with a chemical bond, atom or radical of the same kind.

3. The catalyst composition for olefin polymerization according to claim 2, wherein X is chloro, bromo, a C₁-C₂₀ lower alkyl group, or an aryl group.

4. The catalyst composition for olefin polymerization according to claim 1, wherein M is a metal element from Group 3, Group 4, or lanthanides;
Xs, being the same or different from each other, are selected from hydrogen, halogen, an alkyl group R, an alkoxyl group OR, a mercapto group SR, a carboxyl group OCOR, an amino group (NR₂), a phosphino group (PR₂), —OR^{o}O— or OSO₂CF₃;
wherein R is a straight or branched C₁-C₂₀ alkyl group, a saturated or unsaturated C₁-C₂₀ alkyl group, a halogenated or non-halogenated C₁-C₂₀ alkyl group, a C₁-C₂₀ alkyl group optionally including a heteroatom from Groups 13 to 17 in the periodic table, a C₃-C₂₀ cycloalkyl group, a C₆-C₃₀ aryl group, an alkyl-substituted aryl group having 7 to 30 carbon atoms, or an aryl-substituted alkyl group having 7 to 30 carbon atoms;
R^{o} is a divalent radical;
in the structure of —OR^{o}O—, the two oxygen atoms may be at any positions of the radical, respectively;
Q is a divalent radical.

5. The catalyst composition for olefin polymerization according to claim 4,
wherein M is zirconium, hafnium or titanium from Group 4.

6-9. (canceled)

10. The catalyst composition for olefin polymerization according to claim 1, wherein R′ is methyl, ethyl, isopropyl, trimethylsilyl, phenyl, or benzyl; and E is a biradical of an element of Group 15 or 16 in the periodic table.

11-12. (canceled)

13. The catalyst composition for olefin polymerization according to claim 1, wherein R″ is a C₄-C₁₀ linear alkyl group, phenyl, mono- or multi-substituted phenyl, benzyl, mono- or multi-substituted benzyl, 1-naphthyl, 2-naphthyl, 2-anthryl, 1-phenanthryl, 2-phenanthryl, or 5-phenanthryl.

14. (canceled)

15. The catalyst composition for olefin polymerization according to claim 1, wherein R¹ is selected from hydrogen, methyl, ethyl, isopropyl, t-butyl, phenyl, benzyl, 2-furyl, and 2-thienyl.

16-18. (canceled)

19. The catalyst composition for olefin polymerization according to claim 1, wherein R⁴ is selected from H, methyl, trifluoromethyl, isopropyl, t-butyl, phenyl, p-tert-butyl-phenyl, p-trimethylsilyl-phenyl, p-trifluoromethyl-phenyl, 3,5-dichloro-4-trimethylsilylphenyl, and 2-naphthyl.

20. (canceled)

21. The catalyst composition for olefin polymerization according to claim 1, wherein R⁵ is selected from hydrogen, fluoro, and methyl.

22. The catalyst composition for olefin polymerization according to claim 1, wherein in chemical formulae (V), (VI), (VII) and (VIII), R⁶ and R⁷ are equal to R³.

23. The catalyst composition for olefin polymerization according to claim 22, wherein R⁶ and R⁷ are selected from hydrogen and fluorine.

24. The catalyst composition for olefin polymerization according to claim 1, wherein in chemical formula (I): Z is a π-ligand, wherein Z=A, or Z has a chemical structure represented by the following chemical formula (IX), (X), (XI), (XII) or (XIII): 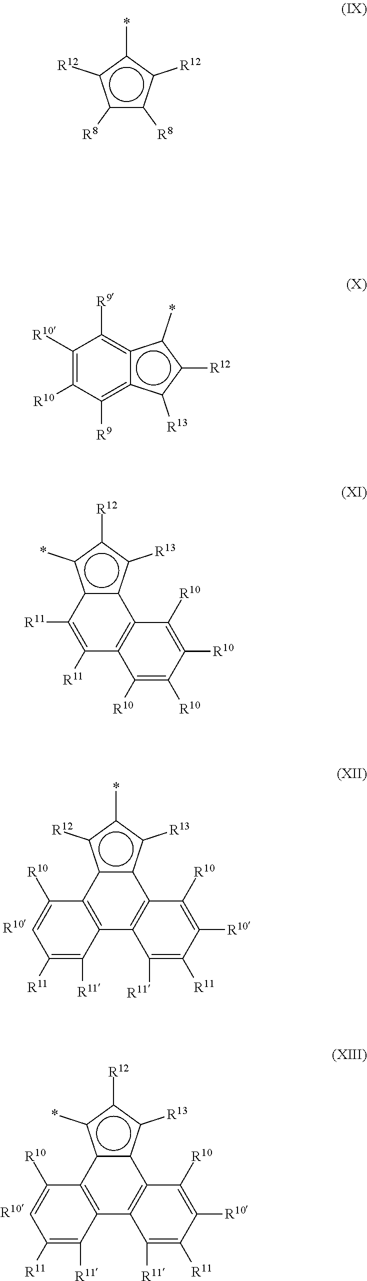
in the above formulae (IX), (X), (XI), (XII) and (XIII):
R¹ is methyl, ethyl, isopropyl, t-butyl, phenyl, benzyl, 2-furyl, or 2-thienyl;
R² is hydrogen.

25-34. (canceled)

35. A method for preparing the catalyst composition for olefin polymerization according to claim 1, comprising: mixing the main catalyst with the fluorinated silica gel support in a homogeneous liquid medium for reaction, wherein the homogeneous liquid medium comprises a saturated alkane liquid medium and an aromatic liquid medium, the saturated alkane includes pentane and isomers thereof, hexane and isomers thereof, heptane and isomers thereof, as well as octanes and isomers thereof, and the aromatic liquid medium includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof;
the fluorinated silica gel support is prepared by: dispersing dehydrated silica gel in an organic solvent at a dispersion temperature of −30° C. to 120° C.; at that temperature, contacting the dispersion with a fluoride or with a fluoride and fatty alcohol for 0.5 to 10 h; filtering the solid, washing it with an organic solvent, and drying it; after that, heating the resultant under an oxygen atmosphere at 200 to 500° C. for 1 to 6 h, and then heating the resultant under an argon atmosphere at 200 to 500° C. for 1 to 6 h, to obtain the support;
the dehydration condition is vacuum at 200-700° C.; the organic solvent is toluene, hexane or heptane; the fluoride is dialkylaluminum fluoride; the fluoride is fed in a ratio of 1-100 mmol/g of the silica gel.

36-39. (canceled)

40. A method for catalytic polymerization of an olefin CH2=CHR, comprising: using the catalyst composition for olefin polymerization to catalyze polymerization of an olefin CH2=CHR, wherein R is hydrogen or a hydrocarbon group containing 1-12 carbon atoms;
the catalyst composition for olefin polymerization is the catalyst composition for olefin polymerization according to claim 1 or, the catalyst composition for olefin polymerization comprises the catalyst composition for olefin polymerization according to claim 1, and further comprises a Lewis acid substance LA; the LA is a polymethylaluminoxane or modified polymethylaluminoxane having simultaneously chain-, cyclic- and cage-like structures in equilibrium in a solution or an organic boron reagent.

41. (canceled)

42. The method according to claim 35, wherein the organic solvent is diethylaluminum fluoride, diisopropylaluminum fluoride or dibutylaluminum fluoride.

43. The method according to claim 35, wherein the fluoride is fed in a ratio of 1-50 kg/mol of the silica gel.

44. The method according to claim 40, wherein the mole ratio of the LA to the metallocene complex is 100-300.

45. The method according to claim 40, wherein the method for preparing the catalyst composition for olefin polymerization, comprising: mixing the main catalyst with the fluorinated silica gel support and the Lewis acid substance LA in a homogeneous liquid medium in an arbitrary order for reaction, wherein the homogeneous liquid medium comprises a saturated alkane liquid medium and an aromatic liquid medium, the saturated alkane includes pentane and isomers thereof, hexane and isomers thereof, heptane and isomers thereof, as well as octanes and isomers thereof, and the aromatic liquid medium includes benzene, toluene, xylene and isomers thereof, trimethylbenzene and isomers thereof, chlorobenzene, dichlorobenzene and isomers thereof, fluorobenzene, difluorobenzene and isomers thereof, as well as polyfluorobenzene and isomers thereof.

46. The method according to claim 45, wherein the method for preparing the catalyst composition for olefin polymerization: the reaction temperature is in the range of −75° C. to 150° C., and the reaction duration is in the range of 1 min to 8 h.
